(19) United States
(12) Patent Application Publication
(10) Pub. No.: US 2006/0083976 A1
(43) Pub. Date: Apr. 20, 2006

(54) Substituted nitrogen heterocycles as proton carriers for water-free proton exchange membranes for fuel cells

(75) Inventors: William A. Goddard, Pasadena, CA (US); Wei-Qiao Deng, Pasadena, CA (US); Valeria Molinero, Pasadena, CA (US)

Correspondence Address: REED INTELLECTUAL PROPERTY LAW GROUP, 1400 PAGE MILL ROAD, PALO ALTO, CA, 94304-1124, US

(73) Assignee: California Institute of Technology, Pasadena, CA (US)

(21) Appl. No.: 11/148,766

(22) Filed: Jun. 8, 2005

Related U.S. Application Data
(60) Provisional application No. 60/578,034, filed on Jun. 9, 2004.

(51) Int. Cl. H01M 8/10; C08J 5/22

(52) U.S. Cl. 429/33; 521/27

(57) ABSTRACT

A fuel cell is provided comprising an anode, a cathode, a catalyst, and a polymer electrolyte membrane comprising a heterocyclic compound with a nitrogen heteroatom and at least one electron-withdrawing substituent. The fuel cell operates at temperatures above about 100° C., preferably above about 150° C. The heterocyclic compound is preferably a substituted imidazole or benzoimidazole, most preferably a fluorinated imidazole. The heterocyclic compound is preferably liquid at the fuel cell operating temperature. The catalyst preferably contains platinum. The polymer electrolyte membrane preferably has a conductivity of 10⁻² S/cm² or higher. For efficient fuel cell operation the catalyst should not be poisoned to an undue degree by the heterocyclic compound, and so the binding energy of the heterocyclic compound to the catalyst should be low.

### CROSS-REFERENCE TO RELATED APPLICATIONS

This application claims priority under 35 U.S.C. § 119(e)(1) to Provisional U.S. Patent Application Ser. No. 60/578,034, filed Jun. 8, 2004. The disclosure of this provisional application is incorporated by reference in its entirety.

### TECHNICAL FIELD

This invention relates generally to fuel cells, and specifically to proton exchange membranes for fuel cells.

### BACKGROUND

A fuel cell is an electrochemical cell which produces electrical energy from the chemical energy in a fuel. Despite being known as a means of generating electric energy for many years, fuel cells have generally been employed only for niche applications due to their cost. Compared to conventional generating plants, fuel cells potentially have important advantages in two respects: more efficient conversion of the chemical energy of the fuel to electrical energy and lower levels of pollution.

For general background on fuel cells, please refer to James Larminie & Andrew Dicks, Fuel Cell Systems Explained (Wiley 2d ed. 2003), and to EG&G Services et al., Fuel Cell Handbook (U.S. Department of Energy, 5th ed. 2000).

A common type of fuel cell is the polymer electrolyte fuel cell (PEFC). Such cells are described, for example, in chapter 3 of the Fuel Cell Handbook referenced above. Polymer electrolyte fuel cells have generally been fueled with hydrogen, although methanol-fueled PEFCs are also known. At the anode of a hydrogen-fueled PEFC, a stream of hydrogen gas flows past. The reaction H₂→2H⁺+2e⁻ occurs. The proton H⁺ is transported through the polymer electrolyte. The electron e⁻ passes through the load of the fuel cell, providing electric power. At the cathode, the reaction 2H⁺+2e⁻+½O₂→H₂O typically occurs. The protons which have been transported through the polymer electrolyte reunite with electrons which have passed through the load and, together with oxygen, form water.

It is common to couple fuel cells with a fuel reforming system, e.g., one which generates hydrogen from other substances. Fuel reforming of hydrogen from natural gas may be performed. The advantage of fuel reforming in the vicinity of the fuel cell is that hydrogen is comparatively difficult to transport and store due to its very low molecular weight. Much research has been devoted to efficient storage of hydrogen.

An important issue in fuel cells is the speed of the electrochemical reactions producing the energy. If the electrochemical reactions proceed slowly, then the current obtainable from the fuel cell will be limited. In general, it is necessary to employ catalysts and/or heat the fuel cell to several hundred degrees C. in order to obtain a usable fuel cell. A common catalyst is platinum. Due to the cost of platinum, much effort has gone into designing fuel cells which can achieve desirable levels of conversion of chemical energy into electric energy with a minimum amount of platinum.

In PEFCs, an important issue is catalyst “poisoning” by CO. Practical sources of hydrogen fuel contain some amount of CO. For efficient catalysis by platinum, it has generally been considered necessary to keep the concentration of CO in the fuel in the parts per million range. Otherwise, the CO will adsorb on the platinum catalyst and prevent the areas where it has adsorbed from usefully contributing to catalysis. It takes a significant amount of equipment and energy to reform other fuels into hydrogen fuel with a parts per million level of CO contamination.

PEFCs normally operate around 80° C. The adsorption of CO onto the catalyst would be significantly lessened by higher temperature operation. Higher temperature operation would also speed up the electrochemical reactions. Furthermore, operating at higher temperatures would allow the waste heat of the fuel cell operation to be better employed, for example for heating.

An obstacle to higher temperature operation of PEFCs is the fact that the proton conductivity of the electrolyte in a PEFC is highly dependent on its water content. It is considerably more difficult to maintain an adequate water content in a PEFC if it is operated close to or above the boiling point of water.

An approach which has been attempted for higher temperature operation of PEFCs is the use of a different liquid in place of water. Imidazole was proposed for this purpose. However, it did not work out well due to its poisoning of the platinum catalysts which are usually used. See in this regard C. Yang et al., “Approaches and technical challenges to high temperature operation of proton exchange membrane fuel cells,” Journal of Power Sources, volume 103, pp. 1-9 (2001).

There is therefore a need in the art for a polymer electrolyte fuel cell which can operate at higher temperatures, particularly temperatures above the boiling point of water.

### SUMMARY OF THE INVENTION

In one embodiment of the invention, a polymer electrolyte membrane for a fuel cell is provided. The polymer electrolyte membrane comprises a proton-conducting polymer and a heterocyclic compound with a nitrogen heteroatom and at least one electron-withdrawing substituent.

In a further embodiment of the invention, a fuel cell is provided comprising an anode, a cathode, a polymer electrolyte membrane comprising a substance other than water which is a liquid under normal operating conditions, and a catalyst containing platinum. The fuel cell operates at temperatures above about 100° C. and the platinum-containing catalyst is not poisoned by the substance other than water.

In a further embodiment of the invention, a fuel cell is provided comprising an anode, a cathode, a polymer electrolyte membrane comprising a heterocyclic compound with a nitrogen heteroatom and at least one electron-withdrawing substituent, a cathode, and a catalyst. The fuel cell operates at temperatures above about 100° C.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 depicts the process of “proton hopping” between two molecules of imidazole.

FIG. 2 depicts schematically a fuel cell of the invention.

FIG. 3 depicts the ground state positions of the atomic nuclei of imidazoles (top left) and trifluoroimidazole (top right, bottom) as adsorbed on the (111) face of a platinum crystal.

FIG. 4 depicts the barriers to proton hopping in imidazole (top) and trifluoroimidazole (bottom), calculated in vacuum.

FIG. 5 depicts the barriers to proton hopping in water, imidazole, and trifluoroimidazole, calculated both in vacuum and taking into account solvent effects. Circles are proton hopping barriers between water dimers; squares are proton hopping barriers between imidazole dimers; triangles are proton hopping barriers between trifluoroimidazole dimers. Solid symbols indicate data after solvent correction. Hollow symbols indicate vacuum data without solvent correction.

FIG. 6 depicts the radial distribution function g(r) between donor and acceptor sites for imidazole and trifluoroimidazole Nafion membranes.

### DETAILED DESCRIPTION OF EMBODIMENTS OF THE INVENTION

Before describing the present invention in detail, it is to be understood that this invention is not limited to specific solvents, materials, or device structures, as such may vary. It is also to be understood that the terminology used herein is for the purpose of describing particular embodiments only, and is not intended to be limiting.

As used in this specification and the appended claims, the singular forms “a,” “an,” and “the” include both singular and plural referents unless the context clearly dictates otherwise. Thus, for example, reference to “a nitrogen atom” includes a plurality of nitrogen atoms as well as a single nitrogen atom, reference to “a temperature” includes a plurality of temperatures as well as single temperature, and the like.

The term “Nafion-type polymer” refers to a polymer material having the formula 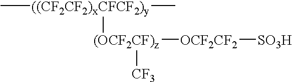
for integer x, y, and z.

The term “nitrogen heterocycle” refers to an organic compound which has at least one cycle and has at least one nitrogen heteroatom in a cycle. Other heteroatoms are permitted besides the at least one nitrogen heteroatom.

“Optional” or “optionally” means that the subsequently described circumstance may or may not occur, so that the description includes instances where the circumstance occurs and instances where it does not.

In one embodiment of the invention, a polymer electrolyte membrane for a fuel cell is provided. The polymer electrolyte membrane comprises a proton-conducting polymer and a heterocyclic compound with a nitrogen heteroatom and at least one electron-withdrawing substituent.

Widely used polymer electrolyte membranes for fuel cells employ sulfonated perfluoro polymers of the class marketed by Du Pont as Nafion. There are various grades of Nafion marketed by Du Pont. The polymers of which these membranes are made have the advantages of having been known, used, and studied for many years. However, in the manner that they are commonly used in fuel cells, the membranes need to contain substantial amounts of water for adequate conductivity, which is an obstacle to higher temperature operation of the fuel cell.

For this reason, the polymer electrolyte membranes of the invention preferably contain, in addition to the polymer, a heterocyclic compound with a nitrogen heteroatom and at least one electron-withdrawing substituent. The electron-withdrawing ability of the substituent may be ascertained, for example, by means of electronegativity scales (e.g., the Pauling scale or the Sanderson scale), or by quantum mechanical calculations of electron density with and without the substituent. The electron-withdrawing substituent preferably has a Pauling electronegativity of at least about 3. The substituent is preferably a halogen, and most preferably fluorine. There are preferably two nitrogen heteroatoms in the heterocyclic compound. Preferably, one of the nitrogen heteroatoms has an attached hydrogen in the neutral molecule and the other does not.

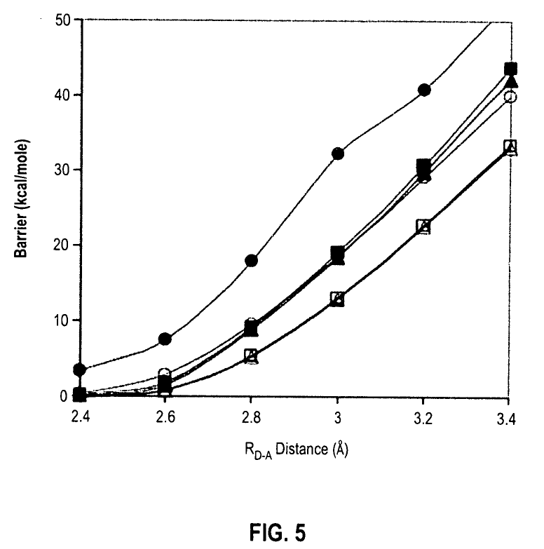

The heterocyclic compound of the polymer electrolytes of the invention should be liquid at the desired operating temperatures. Generally speaking preferred fuel cell operating temperatures are between 100° C. and 300° C., more preferably between 150° C. and 250° C. One reason why temperatures about 150° C. are preferred with platinum-containing catalysts is that at such temperatures a fuel with up to 100 ppm of CO would be expected to have a roughly similar poisoning effect to 10 ppm CO fuel at the usual current PEFC operating temperature of 80° C. See in this regard FIG. 5 of Yang et al.

Particularly preferred substituted heterocyclic compounds are the fluorinated imidazoles, for example 2-fluoroimidazole, 4-fluoromidazole, 5-fluoroimidazole, 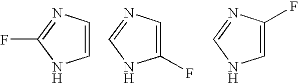
2,4-difluoroimidazole, 2,5-difluoroimidazole, 4,5-difluoroimidazole, 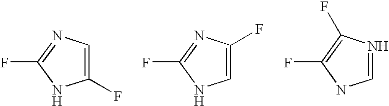
or trifluoroimidazole (2,4,5-trifluoroimidazole), 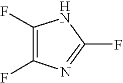
Fluorinated benzimidazoles are also preferred.

The synthesis of heterocyclic compounds is generally known. See in this regard T. L. Gilchrist, Heterocyclic Chemistry (2nd ed., Longman Scientific & Technical, 1992) and Comprehensive Heterocyclic Chemistry (A. Katritzky, Ch. Rees, E. Scriven eds., Elsevier 1996). With regard to the synthesis of substituted imidazoles in particular see the contribution of M. R. Grimmett in Comprehensive Heterocyclic Chemistry, volume 3, and K. Ebel in Houben-Weyl, Methoden der Organischen Chemie (Georg Thieme Verlag 1994), Vol. E8c, Hetarene. See also Bohumil Dolensky et al., J. Fluorine Chem., 107(1), 147-48 (2001), and Kenneth L. Kirk & Louis A. Cohen, JACS, 93(12), 3060-61 (1971).

Without wishing to be bound by theory, the desirability of an electron-withdrawing substituent appears to be related to stabilization of the sp² lone pair on a nitrogen heteroatom. As the inventors have discovered through quantum mechanical computations explained in more detail below, it appears that the stabilization of the sp² lone pair decreases the ability of heterocyclic compounds with a nitrogen heteroatom to bind to the common catalyst platinum by sharing of an unoccupied orbital of the platinum atoms on the catalyst surface. This decreased ability to bind is believed to lead to considerably reduced catalyst poisoning.

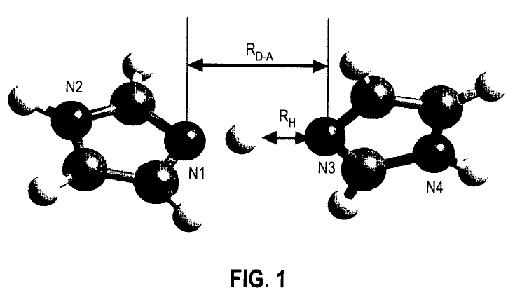

Also without wishing to be bound by theory, heterocycles comprising two nitrogens, where one nitrogen has a bound hydrogen in the neutral molecule, appear to be desirable for proton-transfer electrolyte applications because they readily accept a proton, forming a positive ion, and readily transfer the proton from that positive ion to a neutral molecule in a process referred to as “proton hopping.” The electron-withdrawing substituent preferably does not have a large adverse effect on this process of proton hopping, sterically or otherwise. The proton hopping process for imidazole is depicted in FIG. 1.

Substituents also may serve to raise the boiling point of the heterocyclic compounds and raise the vapor pressure. That is in general favorable to higher-temperature operation of the polymer electrolyte membrane comprising those compounds.

The proton-conducting polymer used in the polymer electrolyte membranes of the invention may be sulfonated and/or a perfluoro polymer as indicated above. The well studied Du Pont Nafion polymers are particularly preferred, for example Nafion 117. Other commercial sulfonated perfluoro polymers such as Asahi Kasei Co.'s Aciplex are marketed. In addition, a wide variety of other proton-conducting polymers discussed in the literature may be employed with this invention. In general, organic polymers having a polar group including a strong acid group such as sulfone group and phosphoric acid group and a weak acid group such as carboxyl group are preferably used. For example, the polymers discussed in the following U.S. patents and published applications may be suitable: 2004/0234834, 2003/0148162, U.S. Pat. Nos. 6,893,764, 6,765,027, 6,399,235, and 5,422,411.

The polymer electrolyte membrane may be formed from the proton-conducting polymer and the substituted heterocyclic compound in a variety of ways. A preformed membrane of the polymer may be dipped into a quantity of liquid heterocyclic compound and then the latter may be allowed to recrystallize inside the pores of the preformed membrane. A preformed membrane may alternatively be soaked in a solvent in which the heterocyclic compound is dissolved, with the solvent then evaporated. Alternatively, a solution of both the proton-conducting polymer and the heterocyclic compound may be placed on a suitable substrate, with the solvent then evaporated leaving a membrane. For suitable polymers, it may be possible to include the heterocyclic compound in the mixture as polymerization is occurring and to cast the resulting polymer-heterocyclic compound mix from solution.

The polymer electrode membrane preferably has a high conductivity. A conductivity above 10⁻⁴ S/cm is preferred, preferably above 10⁻³ S/cm, and more preferably above about 10⁻² S/cm. Conductivities in this range result in relatively modest ohmic losses from the resistance of the polymer electrolyte membrane, improving the efficiency of the overall system.

In a further embodiment of the invention, a fuel cell is provided comprising an anode, a cathode, a polymer electrolyte membrane comprising a substance other than water which is a liquid under normal operating conditions, and a catalyst comprising platinum. The fuel cell operates at temperatures above about 100° C. and the platinum-containing catalyst is not poisoned by the substance other than water.

The substance other than water in the fuel cells of the invention is preferably a heterocyclic compound with a nitrogen heteroatom and at least one electron-withdrawing substituent, as discussed above. As further noted above, two nitrogen heteroatoms of which one is protonated in the neutral molecule are particularly preferred.

The anodes and cathodes of the fuel cells of the invention preferably comprise fine carbon-containing particles, sized on the order of tens of nanometers, to which yet finer particles of catalyst have adhered, all set upon a carbon-fiber paper backing. An advantage of very fine catalyst particles is that a large surface area is offered upon which catalysis can occur. The anode and cathode are preferably on the order of some tens of micrometers thick. A binder may be used in the cathode and anode, for example polytetrafluoroethylene or Nafion. The catalyst-carbon particles and binder may be sprayed, for example, on the carbon-fiber paper backing in order to form the electrode. The anode, polymer electrolyte membrane, and cathode are preferably sandwiched together to form what is commonly referred to as a membrane electrode assembly (MEA). This assembly may be formed, for example, by hot pressing two electrodes onto a polymer electrolyte membrane. The overall thickness of the MEA is preferably roughly in the range of 30 to 300 μm.

The platinum-containing catalyst of the invention may be pure platinum or may be an alloy of platinum with some other metal, such as Ru, Sn, or Mo. It has been found that alloys of platinum are at least in some circumstances less easily poisoned by CO than pure platinum. The catalyst may be different for the anode and the cathode. In other embodiments of the invention, non-platinum-containing catalysts may be employed.

The fuel cells of the invention may be designed to operate with hydrogen fuel, giving the reactions as set out above in the Background. They may also be designed for operation with methanol fuel, in much the same manner that fuel cells with current water-containing electrolyte membranes are used, or with other fuels such as ethanol. The anode reaction in methanol fuel cells may be CH₃OH+H₂O→CO₂+6H⁺+6e⁻; the cathode reaction may be 3/2O₂+6H⁺+6e⁻→3H₂O. Methanol fuel cells have the advantage that methanol fuel is easier to store and distribute than hydrogen on account of being liquid, and no reforming process is required. Higher temperature operation, as with the fuel cells of the invention, has advantages where methanol is used as fuel, for example because it can increase reaction rates. For further information regarding fuels such as methanol, please refer to U.S. Pat. No. 6,821,659.

The fuel cells of the invention may operate with the fuel and/or oxidizer at atmospheric pressure or at a different pressure. While higher pressures up to five times atmospheric pressure have been considered as a way of operating fuel cells with water-containing membranes at higher temperatures (since increasing the pressure increases the boiling point of water), it has been found that such higher pressures also have disadvantages. In general a controllable pressure of fuel and oxidizer is preferred, using fluid flow control equipment known in the art which is suitable for operation at the temperatures and pressures being used.

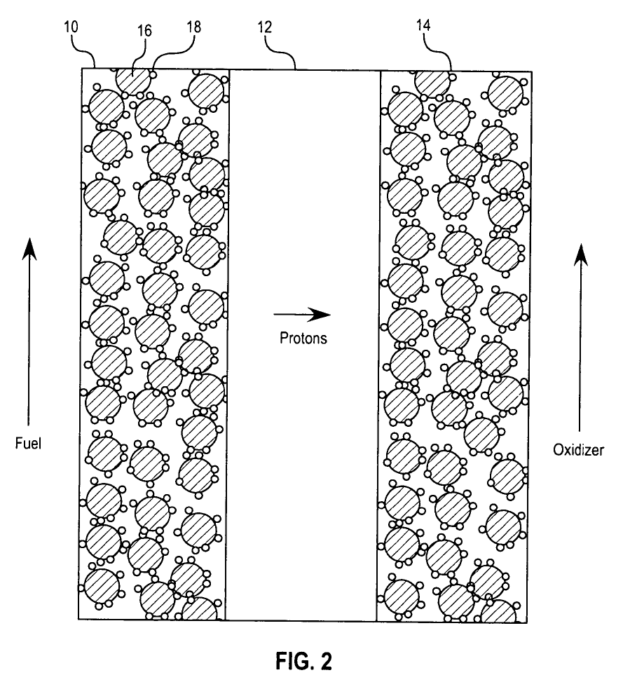

FIG. 2 depicts schematically (not to scale) an exemplary fuel cell of the invention. It is seen that there is a flow of fuel (for example hydrogen) past an anode 10. The flow of fuel is indicated by an arrow. The anode 10 is attached to a polymer electrolyte membrane 12, which is in turn attached to a cathode 14. Past the cathode 14 there is a flow of oxidizer (for example air or pure oxygen), indicated by an arrow. Through the polymer electrolyte membrane there is a flow of protons as a consequence of the electrochemical reactions taking place at anode and cathode. As discussed above, the anode and cathode preferably comprise small particles 16 which serve to support a catalyst 18.

The fuel cells of the invention may preferably be stacked into assemblies. Their electrodes may be connected in series to achieve a higher voltage than each fuel cell individually achieves. They may also be arranged in an electrically parallel connection so that multiple fuel cells are each contributing current to a load. Combinations of series and parallel electrical connection are also possible. In such stacks, fuel and oxidizer may enter through a manifold so as to reach each individual fuel cell. The area between stacked fuel cells is conveniently occupied by a bipolar plate which is capable of serving as a separator between electrodes of adjacent fuel cells while forming passageways for gas or fuel supply to the electrodes.

Fuel cell assemblies may directly provide DC power to a load such as a regulated DC power supply or an electronic system. Alternatively they may drive a DC-to-AC inverter to provide AC power and potentially, for example, feed an electric power grid.

In general the fuel cells of the invention will preferably possess temperature controllers. The fuel cells may require in some circumstances external heating, particularly during the start up phase. The heat evolved in the fuel cells of the invention is preferably used to heat incoming gases or to heat other media, for example, through heat exchangers. The fuel cells of the invention may be part of a system which produces both steam and electric power (a combined heat and power system). Steam may naturally be produced at the cathode of such fuel cells as a result of the cathode reaction producing water. Higher temperature operation is a significant advantage for integration in such systems and may make fuel cells of the invention competitive with current commercial phosphoric acid fuel cells in larger installations.

The following performance information is included herein to provide a further understanding of the inventive electrolytes and the improved fuel cell characteristics provided thereby over other electrolyte materials. It is to be understood that this information is provided herein for the purposes of illustration only and is not to be interpreted as limiting the claimed invention in any way.

In order to analyze the performance of a preferred polymer electrolyte, a number of studies were conducted which involved numerical computations based on quantum mechanics and molecular dynamics. In a first study, the binding energies of imidazole and perfluorimidazole adsorbed on a platinum crystal surface were computed. In a second study, the barriers for protons to pass from one imidazole and trifluoroimidazole molecule to another in close proximity were computed. In a third study, the motion of trifluoroimidazole molecules in the vicinity of a Nafion polymer backbone in thermal equilibrium at a temperature of 450 K was simulated. From this simulation and the results of the second study the diffusion coefficients of the trifluoroimidazole molecules and the contribution to proton diffusion of proton “hopping” from one trifluoroimidazole molecule to another were calculated.

The binding energy study involved computing the ground state electron density and electronic energy of a trifluoroimidazole molecule at different distances and orientations with respect to a platinum crystal. As is well known, given fixed positions of the nuclei of the atoms, Schrödinger's equation allows the ground state electron density and electronic energy to be computed. If the positions of the nuclei are not known, they may be determined by starting with a plausible initial guess for those positions and adjusting them until the ground state electronic energy predicted by an approximate solution of Schrödinger's equation, minus the internuclear electrostatic repulsion energy, is minimized. There are various techniques which are used to obtain approximate numerical solutions of Schrödinger's equation in this context. The computation of the ground state electron density and energy described here employed density functional theory (DFT), which is described in many books and articles.

In the proton hopping barrier study, a geometric arrangement of a trifluoroimidazolium ion and a trifluoroimidazole molecule as depicted in FIG. 1 was assumed. The distances between the proton and the two nitrogens between which the proton “hops” were allowed to vary. The relative orientation of the two rings in space was also allowed to vary. The ground state energy was computed for each of a series of distances, again employing DFT. This study employed, as discussed below, corrections to take into account the presence of the surrounding solvent.

The motion simulation employed well known tools of molecular dynamics. In a simplified summary, the following steps were carried out. Equations for force fields between different atoms making up the simulated imidazole and trifluoroimidazole molecules and Nafion polymers were selected to give accurate predictions based on experience and results reported in the literature. Many such force field equations are known in the art. Plausible initial positions of a set of ionized and non-ionized molecules and polymers were assumed. The equations of motion were solved with the assumed force field equations. The evolution of the atomic positions over time was recorded. A certain amount of time was allowed for equilibrium to be achieved at a temperature of 450 K. The simulated evolution following that time was used to compute macroscopic parameters, such as diffusion coefficients, using standard formulas of statistical mechanics.

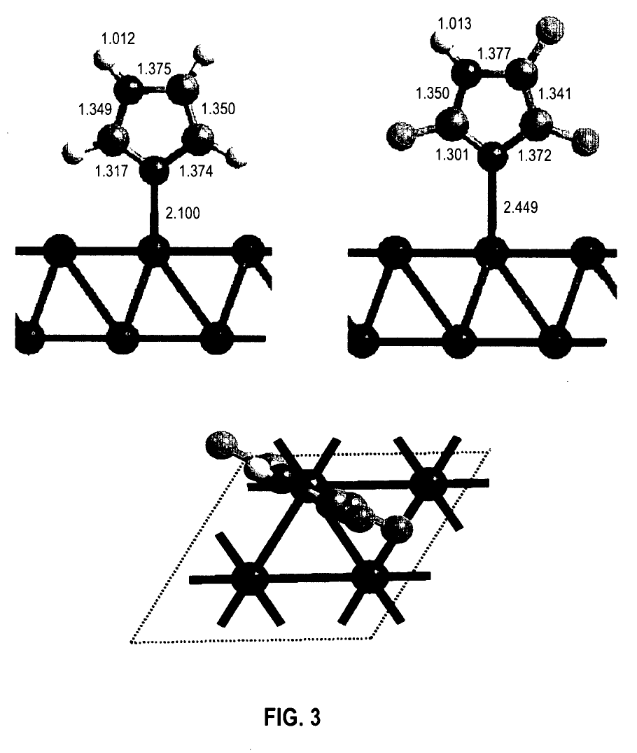

In summary, the results achieved in these studies were as follows. First, it was found that trifluoroimidazole does not adsorb significantly on platinum. The ground state arrangement of imidazole and trifluoroimidazole relative to a (111) face of a platinum crystal was as depicted in FIG. 3. The binding energy of imidazole is 21.1 kcal/mol as calculated; for 2-fluoroimidazole it is 10.5 kcal/mole, for 4,5-difluoroimidazole it is 10.3 kcaumole, and for trifluoroimidazole it is 1.3 kcaumol. For comparative purposes, the same calculational technique predicts binding energies of 38.5 kcal/mol for CO (experimental 42.3±6.7 kcal/mol) and 11.0 kcal/mol for H₂O (experimental 12.5 kcal/mol). As depicted in FIG. 3, the adsorbate heterocyclic ring is perpendicular to the Pt surface. In this configuration, the sp² lone pair of the N binds to a surface Pt atom. The effect of fluorination is to reduce the electronic density in the sp² lone pair orbital of the N, decreasing the binding energy to just 1.3 kcal/mole for trifluoroimidazole. The Pt—N bond length illustrates the same trend, increasing from 2.10 Å for imidazole to 2.45 Å for trifluoroimidazole.

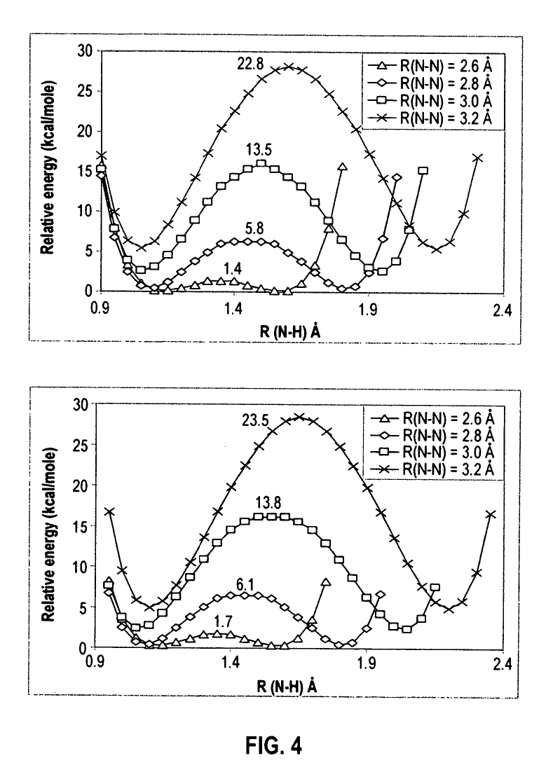

Second, it was found that fluorination of the imidazole left the barriers to proton transfer from a nitrogen on a positive ion to a nitrogen on a neutral molecule essentially unaltered. The hopping barriers depend strongly on the distance r between the proton donor and acceptor, as can be seen in FIG. 4, but not significantly on the fluorination of the carrier.

Third, in the motion simulation results the proton diffusion coefficients D were calculated, giving the results shown in the following table:

TABLE 1
Simulated proton diffusion coefficient of Nafion/imidazole complex.

| | | D_{V} | D_{H} | D |
|---|---|---|---|---|
| | T (K) | (10⁻⁵ cm²/s) | (10⁻⁵ cm²/s) | (10⁻⁵ cm²/s) |
| Nafion + imidazole | 450 | 0.15 | 0.30 | 0.45 |
| Nafion + | 450 | 0.12 | 0.13 | 0.25 |
| trifluoroimidazole | | | | |
| Water | 300 | 1.52 | 1.63 | 3.15 |

In this table, the total diffusion coefficient D is broken out into “vehicular” diffusion Dᵥ—meaning diffusion of a proton while it forms part of an imidazole or trifluoroimidazole ion—and “proton hopping” diffusion D_{H}. The entry for water is for comparative purposes to show the accuracy of the method. The experimental value of the total diffusion coefficient D for water at the indicated temperature is 9.3×10⁻⁵ cm²/s.

The falloff in proton hopping diffusion coefficient D_{H} which caused the decline in total diffusion coefficient for trifluoroimidazole was due to the fact that the close approach of molecules which produces the lowest barriers to hopping was found in the motion simulation to be less likely for trifluoroimidazole than for imidazole. This decline in the occurrence of close approaches was presumably caused by the greater bulk of F compared to H.

As a result of the falloff in proton hopping, the diffusion coefficient is 44% lower for trifluoroimidazole than for imidazole. Yang et al., cited above, give the conductivity of a Nafion/imidazole polymer electrolyte membrane as ˜0.1 S/cm at 450 K. From the diffusion coefficient results above, we infer that the conductivity of a Nafion/trifluoroimidazole polymer electrolyte membrane at 450 K would be the Yang et al. value reduced by 44%, or ˜0.06 S/cm.

For purposes of the remainder of the written description of this application, the following literature reference numbers are used to describe publications which help to understand the steps carried out in the studies. (1). Accelrys, Inc. Cerius2 Modeling Environment, Release 4.0 (Accelrys Inc., San Diego, 1999). (2) Perdew, J. P.; Chevary, J. A.; Vosko, S. H.; Jackson, K. A.; Pederson, M. R.; Singh, D. J. and Fiohals, C. Phys. Rev. B 1992, 46, 6671. (3) Lin, J. S.; Qteish, A.; Payne, M. C.; and Heine, V.; Phys. Rev. B 1993, 47,4174. (4) Plimpton, S. J. J. Comp. Phys. 1995, 117, 1. (5) Plimpton, S. J.; Pollock, R.; Stevens, M. In the Eighth SIAM Conference on Parallel Processingfor Scientific Computing: Minneapolis, 1997. (6) Verlet, L. Phys. Rev. 1967, 159, 98. (7) Hockney, Roger W.; Eastwood, James W. Computer simulation using particles (McGraw-Hill International Book Co., 1981). (8) Mayo, S. L.; Olafson, B. D.; Goddard, William. A. J. Phys. Chem. 1990, 94, 8897. (9) Jang, Seung Soon; Blanco, Mario; Goddard, William A.; Caldwell, Gregg; Ross, Richard B. Macromolecules 2003, 36, 5331 (10) Levitt, Michael; Hirshberg, Miriam; Sharon, Ruth; Laidig, Keith E.; Daggett, Valerie J. Phys. Chem. B 1997, 101, 5051. (11) Jang, Seung Soon; Molinero, Valeria; Cagin, Tahir; Goddard III, William A. J. Phys. Chem. B 2004, 108, 3149-3157. (12) Geschke D, Bastug T, Jacob T, Fritzsche S, Sepp WD, Fricke B, Varga S, Anton J., Phys. Rev. B 2001, 64, 235411. (13) Ogletree DF, van Hove MA, Somorjai GA, Surf. Sci. 1986, 173, 351. (14) Blackman, G. S.; Ogletree, D. F.; van Hove, M. A.; and Somorjai, G. A.; Phys. Rev. Lett. 1988, 61, 2352. (15) http://www.vega-g.de/inh/e/en/DK-Wert-Liste_en.pdf. (16) Yeo, Y. Y.; Vattuone, L.; and King, D. A. J. Chem. Phys. 1997, 106, 392.

Pt electrode poisoning problem. In order to study the poisoning of platinum in the presence of imidazoles, we used CASTEP (reference 1 listed above) to calculate the binding energy between imidazole derivatives and platinum surface. A periodic slab that includes two layers of platinum totalizing 8 atoms was used to describe Pt (111) surface. The unit cell c parameter was set to be 16 Å at z direction for keeping 50% of the unit cell as vacuum in order to avoid any interaction between slabs. The calculations were performed by using nonlocal density functional theory (DFT) with the generalized gradient approximation (GGA-II) (reference 2 listed above) and periodic boundary conditions. We used the norm-conserving plane wave pseudopotentials generated with the optimization scheme of Lin et al. (reference 3 listed above). We found significant changes in relative energetics for cutoffs up to 600 eV, requiring a cutoff of 940 eV to obtain convergence. We found that a k-point sampling of 2×2×1 was sufficient for convergence. All energies were extrapolated to 0 K using the correction technique of Gillan and De Vita (reference 4 listed above). All calculations were performed with the CASTEP code in the CERIUS2 software package (reference 1 listed above).

As comparison, we also studied the CO and H₂O adsorbed on the platinum surface. Table S2 shows that bond distances of top position Pt—CO are in good agreement with the experimental value and the bond distances of bridge position Pt—CO is 0.020 Å shorter than experimental value.

TABLE S1
Comparison of adsorption energies for CO on Pt computed in the current
work with experimental results and other simulation results.
(E in kcal/mole)

| Energy functional | Top position | Bridge position | Three fold hollow |
|---|---|---|---|
| GGAII^{a} | 38.5 | 37.8 | 37.1 |
| B88/P86^{b} | 53.0 | 43.1 | 38.0 |
| experiment^{c} | 42.3 ± 6.7 | | |

^{a}this work,
^{b}Ref. 12
^{c}Ref. 16.

TABLE S2
Comparison of bond distances of CO adsorbed on Pt surface of
current work with experimental results and other simulation
results. (Distances in Å)

| Energy functional | Top position | Bridge position | Three fold hollow |
|---|---|---|---|
| GGAII | 1.852 | 2.021 | 2.095 |
| B88/P86 | 1.89 | 1.99 | |
| experiment | 1.85 ± 0.10 | 2.08 ± 0.07 | |

a) this work,
b) Ref. 12
c) Refs. 13 and 14

The second calculation we used for validation was the binding of water molecule with the Pt 111 surface, that is to have considered slight or no poisoning effects. By using the same calculation method as for CO, we found that the most stable binding site has a binding energy of 11.0 kcal/mole and corresponds to water over the top position. This result compares well with the experimental value of 12.5 kcal/mole. The imidazole molecule has an sp² lone pair orbital that is easy to bind with a Pt surface vacant orbital to make a large binding energy. Our DFT calculation indicates that a ¼ coverage imidazole layer on platinum surface will have 21.1 kcal/mole binding energy which is twice water's binding energy with platinum surface. The large binding energy between platinum surface and imidazole will keep activated species such as H₂ away from surface and thus block further reactions. To reduce the binding energy between platinum and imidazole, we consider that replacing H for an electron-acceptor such as the fluoro groups at the ring carbons will stabilize the sp² lone pair orbital and thus increase the mismatch between sp² lone pair and platinum surface vacant orbitals, responsible for the binding. The DFT calculation results in Table S3 shows the effect of fluorination on lowering the energy of the sp² orbital from −9.9 eV for imidazole (Im) to −11.3 eV for 2,4,5-trifluoroimidazole (ImF3). The energy of the platinum surface vacant orbital is −5.66 eV, according to the CASTEP calculation. As expected, the mismatch between sp² lone pair of substituted imidazole and platinum vacant surface orbital has increased with the fluorination, with a concomitant decrease in the binding energy of the molecule to the surface (see Table S3).

TABLE S3
Computed binding energies of water, CO, Im and ImF3 to the Pt surface.

| | Top position Binding energy | Bond |
|---|---|---|
| Energy functional | (kcal/mol) | distance(Å) |
| Water | 11.0 | 2.142 |
| CO | 38.5 | 2.095 |
| Imidazole | 21.1 | 2.100 |
| 2,4,5-trifluoroimidazole | 1.3 | 2.449 |

The energies listed in Table S3 correspond to the binding energies of the monolayer to the Pt electrode. We also computed the intermolecular energy between the Im (or ImF3) in the monolayer, and found that is less than 1 kcal/mole. We have considered other geometries for the binding of the Im and ImF3 to the Pt surface, and we found that the binding with the molecule plane perpendicular to the surface, with the bare N over a top position of the Pt (111) provides the highest binding energy. The binding energies of ImF3 perpendicular to the surface with the N over the three-fold FCC site is 0.92 kcal/mole, over the bridge site is 0.57 kcal/mole. We have also considered the binding of the ImF3 molecule parallel to the Pt surface, and found that the binding energy is even lower than the observed for the perpendicular geometry, confirming the absence of any poisoning effect of the ImF3 on Pt.

Molecular dynamics simulations of Im and ImF3 impregnated Nafion membranes and water-H₃O⁺ system. In this section we describe the methodologies used to investigate the proton diffusion in the imidazole and trifluoroimidazole impregnated Nafion membranes, and for hydronium in water.

The Nafion/imidazole systems were modeled with fully atomistic detail using classical Molecular Dynamics in the canonical (NVT) and isobaric-isothermal ensemble (NPT). The calculations were performed using LAMMPS (Large-scale Atomic/Molecular Massively Parallel Simulator) code from Plimpton at Sandia (see references 4 and 5 above), which was modified to handle our force fields (see references 9 and 11 above). The equations of motion were integrated using the Verlet algorithm (reference 6 above) with a time step of 1.0 fs, and the Particle-Particle Particle-Mesh (PPPM) method (reference 7 above) was used for long range electrostatic interactions in the periodic cells. The inter- and intramolecular interactions were described through the DREIDING force field (reference 8 above) in the version that improves the description of the fluorocarbon moieties (reference 9 above). Water is modeled using the F3C force field (reference 10 above). The force field details, charges, parameters, and application in the study of the structure and dynamics of hydrated Nafion membranes has been extensively described in a recent publication, reference 11 above. The imidazole, imidazolium, trifluoroimidazole, and trifluoroimidazolium force field parameters correspond to the original DREIDING force field. The partial charges on the atomic sites of imidazole and trifluoroimidazole correspond to the Mulliken charges computed from Quantum Mechanics optimization of the molecules in vacuum using B3LYP/6-311G* * and are listed in Table S4.

TABLE S4
The atomic charges for imidazoles and protonated imidazoles.

| | ImH⁺ | Im | ImF3H⁺ | ImF3 |
|---|---|---|---|---|
| N₁ | −0.1953 | −0.5479 | −0.2838 | −0.6311 |
| C₂ | 0.1446 | 0.2063 | 0.4642 | 0.6701 |
| N₃ | −0.1953 | −0.4228 | −0.2838 | −0.4809 |
| C₄ | −0.0978 | −0.0301 | 0.2500 | 0.4067 |
| C₅ | −0.0978 | 0.01816 | 0.2500 | 0.4217 |
| H₁ | 0.3666 | 0.3344 | 0.4097 | 0.3638 |
| H₂/F₂ | 0.2452 | 0.1546 | −0.0827 | −0.2402 |
| H₃ | 0.3666 | — | 0.4097 | — |
| H₄/F₄ | 0.2316 | 0.1354 | −0.0667 | −0.2583 |
| H₅/F₅ | 0.2316 | 0.1520 | −0.0667 | −0.2517 |

The labeling of the atoms for the charge assignment is indicated in the following scheme:

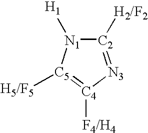

We have prepared periodic simulation cells containing each four ionized Nafion chains, 40 protonated imidazolium (ImH+) (or trifluoroimidazolium (ImF3H+)) and 80 neutral Im or ImF3. Each chain had the dispersed sequence (N₇P)₁₀, where N═(CF₂—CF₂) are the nonpolar TFE segments, and P═(CF₂—CF(O—CF₂—CF(CF₃))—CF₂—CF₂—SO₃H) are the polar perfluorosulfonic vinyl ether (PSVE) segments (see reference 11 above). The total number of atoms in each system was 3848. The proportion of 3 Im molecules per sulfonate of the Nafion chain corresponds to ˜15% wt.

The ImF3/Nafion membranes were created and equilibrated as follows: we started from an equilibrated structure of hydrated Nafion, completely ionized, with 15 water molecules per sulfonate (˜20% wt) at 353 K prepared as indicated in reference 11, then the 560 water and 40 hydronium molecules were removed from the structure, and the polymer was loaded with i) 80 imidazole and 40 imidazolium, or ii) 80 trifluoroimidazole and 40 trifluoroimidazolium. We used the Monte Carlo procedure of the CERIUS2 Sorption Module to load the molecules into the cell. The method was operated at fixed load, and 10⁵ Monte Carlo steps were used to optimize the structures. The system was then equilibrated for 500 ps, performing an NPT dynamics at 450 K. The equilibration of the system was verified monitoring time dependence of the energy and density. Then, a 1 ns equilibrium NPT MD simulation at 450 K was run for each of the two systems. The equilibrium data of this work was collected from these 1 ns trajectories for each of the proton carriers.

The simulation of H₃O⁺ in water was done using the force field described in reference 11 above for the hydrated ionized Nafion membrane. The simulation cell consisted of 200 water molecules, 1H₃O⁺ and 1 CF₃—CF₂—SO₃⁻. We simulated the system using NPT MD dynamics at 300 K and 1 bar using the code and methods describe above for the membranes. The simulation time was of 2 ns, and we collected statistical for the study the diffusion during the last 1.5 ns of the trajectory.

The proton diffusion mechanism includes the combination of two mechanisms, i.e., the vehicular mechanism and hopping mechanism. We use molecular dynamics (MD) to study protonated species, e.g., protonated imidazole and hydronium vehicular diffusion coefficients in Nafion.

Vehicular diffusion of protonated species. The vehicular diffusion of the protonated molecules was calculated from the slope of the mean square displacement (MSD) with time:

$${D}^{MSD} = {lim}_{t \to ∞} \frac{〈 {\vert \vec{r} ( t ) - \vec{r} ( 0 ) \vert}^{2} 〉}{6 t} \qquad ( 1 )$$

where r is the position vector and t is the time, and the brackets indicate an average over all the protonated carriers in the system and over the equilibrium trajectory. The resultant coefficients for the vehicular diffusion of imidazolium and trifluoroimidazolium are indicated in Table 1 above.

Hopping contribution to proton diffusion. The proton transfer rate k(r) between a proton donor and a proton acceptor carrier was computed using transition state theory (TST) with the WKB correction for proton tunneling (see reference 12 above).

$$k ( r ) = κ ( T , r ) \frac{{k}_{B} T}{2 πℏ} exp ( - \frac{{E}_{b} ( r ) - {ℏω}_{1} ( r ) / 2}{{k}_{B} T} )$$

where r is the distance between the donor and acceptor N atoms of the two molecules, E_{b}(r) is the energy barrier to transfer the proton between these N atoms, and ω₁(r) is the frequency of the zero point energy correction.

We used B3LYP/6-311G**++ to scan the potential energy curves for the proton hopping reaction between a protonated and noprotonated (substituted) imidazole. Then, the determined structures at the minima and the saddle points were reoptimized by using Jaguar's Poisson-Boltzmann Self-Consistent Reaction Field model (PB-SCRF). The hopping barrier corresponds to the energy difference between minima and saddle points calculated in solvent media. The experimental dielectric constant for imidazole, ε=23.0 (from reference 15 above), has been used in modeling the solvent. The probe radius is 2.6 Å for imidazole. To validate the theoretical model with a well known system, we also calculated the hopping barrier for the proton between two water molecules using PB-SCRF, with the dielectric constant of water ε=80.37, and a probe radius of 1.4 Å. The coordinates of energy curves are the N—N distance R_{D-A} and the proton-nitrogen distance R_{H} (FIG. 1). For each curve, R_{D-A} is kept constant while R_{H} is increased in increments of 0.01 Å. The calculated potential energy curves for several values of R_{H} are displayed in FIG. 4 (without solvent correction). The activation energy defined as the energy difference between the maximum and minimum points of the curve, decreases significantly as R(N—N) decreases. At fixed R_{H}, the left minimum corresponds to the equilibrium of a left imidazole molecule with a right protonated imidazole, whereas the symmetric minimum located at the right corresponds to a left protonated imidazole in equilibrium with a right imidazole molecule. A transition state for proton transfer corresponds to the maximum point in FIG. 4, i.e., a proton is located equidistant between the two imidazole molecules. From FIG. 4, we observe that, with the increase of the R(N—N) distance, the activation barrier for proton transfer increases sharply, and at a certain small R(N—N) value, the transfer is barrier free. Our results indicate that the proton hopping barrier is barely affected by the fluorination. FIG. 5 shows that the solvent correction does not change this conclusion.

In order to calculate the hopping diffusion constants, we fitted the barrier as a function of distance r between donor and acceptor.
For water, E(r)=26.57(r−1.92)²−3.51 kcal/mole
For imidazole, E(r)=38.40(r−2.30)²−0.99 kcal/mole
For trifluoroimidazole, E(r)=37.27(r−2.30)²−1.24 kcal/mole

Considering a particle hops distance r with hop rate k each time, the diffusion coefficient can be written as:
D=kr² (2)
Therefore, for the case only considering proton hopping between carriers, the diffusion coefficient can be computed from the jump rates:

$${D}_{H} \frac{1}{6 Nt} {\int }_{0}^{t \to ∞} {\sum }_{i}^{N} {\sum }_{j}^{M} {k}_{ij} {r}_{ij}^{2} {P}_{ij} ⅆ t \qquad ( 3 )$$

where kᵢⱼ is the hopping rate from the ith position to the jth position, and the summation is taken over all possible values of i and j. Pᵢⱼ is the probability of an ion being able to jump from site i to site j.

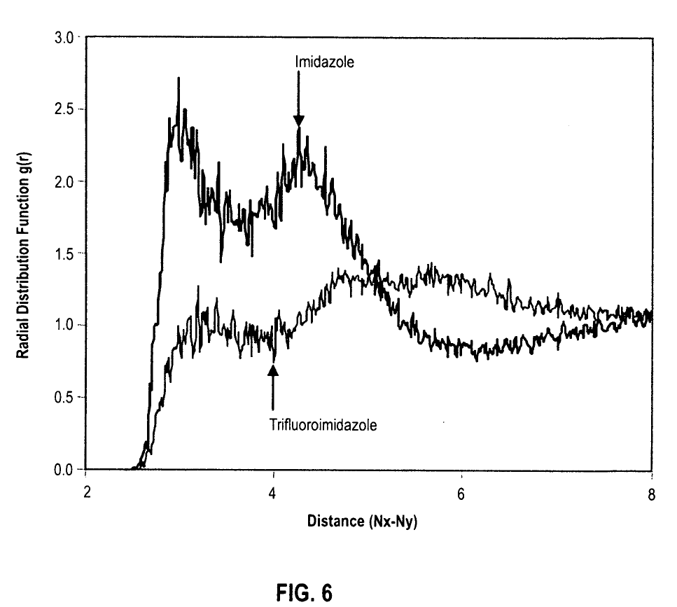

We computed the distances between all pairs of donor and acceptors from the equilibrium molecular dynamics trajectory, and used Equation 3 to compute D_{H}. The distribution of distances between donor and acceptor N over the equilibrium trajectories for the Im/Nafion and ImF3/Nafion membranes is represented also in FIG. 6.

Orientational correlation times for proton carriers in Nafion membranes. We computed the rotational correlation times from the integral of the first order orientational autocorrelation function C₁ for the vector formed by the two nitrogen atoms of each heterocycle:

$${C}_{1} ( t ) = \frac{1}{N} {\sum }_{i = 1}^{N} 〈 cos ( {θ}_{i} ( t ) 〉 \qquad ( 4 )$$

where N is the number of molecules of a given species (Im, ImH⁺, ImF3, or ImF3H⁺), θᵢ(t) is the angle rotated by the unit intramolecular NN vector in a time interval t, and the brackets indicate an average over multiple origins along the 1 ns equilibrium trajectory.

As the noise of the data increases with time t, due to the poorer statistics, we followed the usual custom of fitting the autocorrelation function to a stretched exponential function,
C₁(t)=A exp(−(t/τ)^{β}) (5)
and computed the correlation time analytically from

$$\overline{τ} = \frac{τ}{β} Γ ( \frac{1}{β} ) \qquad ( 6 )$$

The resultant characteristic times for the rotation of the NN versor of the molecule are comparable for the hydrogenated and fluorinated species: 89.3 ps for imidazolium and 112.8 ps for trifluoroimidazolium.

It is to be understood that while the invention has been described in conjunction with the preferred specific embodiments thereof, the foregoing description and the examples that follow are intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties. However, where a patent, patent application, or publication containing express definitions is incorporated by reference, those express definitions should be understood to apply to the incorporated patent, patent application, or publication in which they are found, and not to the remainder of the text of this application, in particular the claims of this application.

We claim:

1. A polymer electrolyte membrane for a fuel cell comprising a proton-conducting polymer and a nitrogen heterocycle substituted with an electron-withdrawing substituent.

2. The polymer electrolyte membrane of claim 1, wherein the polymer is sulfonated.

3. The polymer electrolyte membrane of claim 2, wherein the polymer backbone is substantially fluorinated.

4. The polymer electrolyte membrane of claim 3, wherein the polymer comprises a Nafion-type polymer.

5. The polymer electrolyte membrane of claim 1, wherein the heterocycle comprises two nitrogen heteroatoms.

6. The polymer electrolyte membrane of claim 5, wherein the nitrogen heterocycle has aromatic character.

7. The polymer electrolyte membrane of claim 5, wherein the nitrogen heterocycle is a substituted benzimidazole or imidazole.

8. The polymer electrolyte membrane of claim 1, wherein at least one electron-withdrawing substituent is a halogen.

9. The polymer electrolyte membrane of claim 1, wherein at least one electron-withdrawing substituent has a Pauling electronegativity of at least about 3.

10. The polymer electrolyte membrane of claim 9, wherein at least one electron-withdrawing substituent is fluorine.

11. The polymer electrolyte membrane of claim 5, wherein an electron-withdrawing substituent is found on a carbon in a ring comprising two nitrogen heteroatoms.

12. The polymer electrolyte membrane of claim 11, wherein at least one electron-withdrawing substituent is a halogen.

13. The polymer electrolyte membrane of claim 1, wherein the membrane conductivity is at least about 0.01 S/cm.

14. A fuel cell comprising:
an anode,
a polymer electrolyte comprising a proton-conducting polymer and a proton-conducting substance other than water which is a liquid under normal operating conditions,
a cathode,
a catalyst comprising platinum,
wherein the fuel cell operates at temperatures above about 100° C. and wherein the platinum-containing catalyst is not poisoned by the substance other than water.

15. The fuel cell of claim 14, wherein the platinum-containing catalyst is supported by carbon-containing particles.

16. The fuel cell of claim 14, wherein the platinum-containing catalyst is found at both anode and cathode.

17. The fuel cell of claim 14, wherein the fuel cell operates at temperatures above 150° C.

18. The fuel cell of claim 14, wherein the binding energy for adsorption of the substance other than water to the platinum-containing catalyst is less than 20 kcal/mol.

19. The fuel cell of claim 14, wherein the substance other than water is a heterocyclic compound with a nitrogen heteroatom and at least one electron-withdrawing substituent.

20. The fuel cell of claim 14, wherein the fuel cell operates with fuel containing up to about 25 ppm of CO.

21. The fuel cell of claim 14, wherein the fuel cell operates with fuel containing up to about 100 ppm of CO.

22. The fuel cell of claim 14, wherein the fuel cell operates with fuel containing up to about 250 ppm of CO.

23. The fuel cell of claim 14, wherein the platinum-containing catalyst also contains another metal.

24. The fuel cell of claim 23, wherein the platinum-containing catalyst also contains ruthenium.

25. A fuel cell comprising
an anode,
a polymer electrolyte membrane comprising a heterocyclic compound with a nitrogen heteroatom and an electron-withdrawing substituent,
a cathode,
a catalyst,
wherein the fuel cell operates at temperatures above about 100° C.
